(19) United States
(12) Patent Application Publication
(10) Pub. No.: US 2014/0370197 A1
(43) Pub. Date: Dec. 18, 2014

(54) DEVICE AND METHOD FOR PRODUCING REINFORCEMENTS

(71) Applicants: ContiTech Antriebssysteme GmbH, Hannover (DE); MEP-OLBO GmbH, Fulda (DE)

(72) Inventors: Markus Obert, Hannover (DE); Hubert Goeser, Dannenberg (DE); Stephan Brocke, Hamburg (DE); Jens Kiesewetter, Kuenzell (DE); Andre Kucharczyk, Guelden (DE)

(21) Appl. No.: 14/473,510

(22) Filed: Aug. 29, 2014

Related U.S. Application Data
(63) Continuation of application No. PCT/EP2013/051538, filed on Jan. 28, 2013.

(30) Foreign Application Priority Data
Mar. 1, 2012 (DE) 10 2012 101 739.5

(51) Int. Cl. C08J 5/24; C08K 7/06; B05D 1/18

(52) U.S. Cl. CPC C08J 5/24; B05D 1/18; C08K 7/06; C08J 2375/04
USPC 427/302; 118/500

(57) ABSTRACT

A device and a method for producing impregnated reinforcements, in particular for composite materials such as drive belts. The method for producing the reinforcements includes: introducing the reinforcement into an applicator device; introducing at least one substance for impregnating the reinforcement into the applicator device; and, embodying the impregnated reinforcement. The device comprises at least one applicator through which the reinforcement is guided and at least one intake for a substance for impregnation.

### CROSS REFERENCE TO RELATED APPLICATIONS

This application is a continuation application of international patent application PCT/EP2013/051538, filed Jan. 28, 2013, designating the United States and claiming priority from German application 10 2012 101 739.5, filed Mar. 1, 2012, and the entire content of both applications is incorporated herein by reference.

### FIELD OF THE INVENTION

The invention relates to an apparatus and a process for the production of reinforcement systems, in particular for composite materials such as drive belts.

### BACKGROUND OF THE INVENTION

The mechanical strength of a composite material is substantially dependent on the adhesion between the reinforcing fibers of the reinforcement systems and the polymer matrix. Good adhesion requires not only complete wetting of the individual filaments of the reinforcement system but also an effective bond between matrix and fiber surface. Because of the large dynamic stresses in fiber-reinforced rubber products, reliable provision of adequate adhesion between the composite components is a particular challenge, which is made even more difficult by the dissimilar physical and chemical properties of fiber and polymer (the polarity and high stiffness of the fiber, and the incompatibility and high elasticity of the polymer). For reliable provision of good adhesion in fiber-reinforced polymers it is essential to increase the strength of the chemical and physical interactions between the composite components, and to ensure that the surface tension values and modulus of elasticity values of fiber and matrix are similar. To this end, coupling agents are used, the fiber material being impregnated with these. Typical coupling agents are mixtures of resorcinol-formaldehyde resins and latex (RFL, rubber friendly layer), these generally being applied to the fiber material by dip-coating. However, these often exhibit insufficient adhesion to fiber or matrix.

Both the fiber and the coupling agent have to withstand the relatively high levels of dynamic and thermal stresses. Situations to be avoided here are not only failure of the composite but also any significant change in the properties of the component, for example stiffness or hysteresis behavior. If the material is to have a long lifetime, stringent requirements therefore have to be met by the adhesion between reinforcing fiber and polymer matrix, which depends substantially on the interface and interface layer between the composite components.

The term composite material can by way of example also be applied to a drive belt. Drive belts are also termed force-transmission belts, and in the operating condition are continuous belts that can take the form of flat belts, V-belts, V-ribbed belts, and toothed belts.

Drive belts having very high dynamic strength are often produced from polyurethanes (PUs). When these PU belts are subjected to dynamic load by way of example they are markedly stronger than comparable drive belts without PU. The stress/strain properties of carbon fibers make them ideally suitable for the production of tension members in belts. However, they often suffer from excessively short lifetime when exposed to dynamic stress because of their high stiffness and low transverse strength.

Current reinforcement systems are produced by using aqueous or solvent-based materials in a dip-coating, spraying, or casting process, or via pultrusion processes for PU impregnation. The twisting process that is necessary here in order to achieve good dynamic properties can take place before or after impregnation. Twisting after impregnation has the advantage, in particular for carbon fibers, that the impregnation protects the highly electrically conductive filaments, and carbon fiber dust therefrom, from abrasion, and there is therefore no need for any extremely complicated specialized apparatus. Core-depth impregnation of the untwisted continuous-filament yarn is moreover very much easier to achieve than in the case of twisted yarns, or threads.

However, this has the disadvantage of being very expensive, and the production process is less expensive when the core-depth impregnation process is carried out on the twisted yarns. The core-depth impregnation process serves to sheath each individual filament and thus to protect it from itself and from its neighbors in respect of abrasion.

### SUMMARY OF THE INVENTION

A first object of the present invention is therefore to provide a process which permits improvement of the adhesion properties between reinforcing fibers, in particular carbon fibers, and elastomer, in particular polyurethane, with a view to improved ability of a composite to withstand very high dynamic stress.

Another object of the present invention is to provide an apparatus which permits core-depth impregnation of reinforcement systems, in particular of carbon fibers, and thus increases the lifetime of the reinforcement system.

This first object is achieved via a process for the production of reinforcement system, including at least the following steps:
introduction of the reinforcement system into an applicator apparatus, and
introduction of at least one substance for the impregnation of the reinforcement system into the applicator apparatus, and
discharge of the impregnated reinforcement system.

The second object is achieved via an apparatus which comprises at least one applicator through which the reinforcement system is passed, and at least one inlet for a substance for the impregnation process.

Surprisingly, it has been found that the process of the invention can improve the adhesion properties between reinforcing fibers, in particular carbon fibers, and elastomer, in particular polyurethane, with a view to improved ability of a composite to withstand very high dynamic stress.

The intention is also to provide possibilities for the impregnation of high-performance fibers, alongside the traditional reinforcing fibers. Preference is therefore given to the process for the production of reinforcement systems made of carbon fibers. This requires a coupling agent system that is superior, in terms of adhesion and achieving similar moduli of elasticity, to the RFL dip usually used. In a preferred embodiment, this is achieved via targeted adjustment of interfacial properties (elasticity, hardness, reactivity, or matrix compatibility) by combined use of a reactive primer and of a PU solution which is amenable to targeted property profile adjustment and which ensures good adhesion between fiber and matrix through covalent bonding and controlled roughness, and also achievement of a “spring effect” intended to achieve similar moduli. This takes place in a suitable applicator apparatus which in a particularly suitable embodiment is tubular. It is moreover preferable that the PU for the impregnation of the reinforcement system differs from the PU of the composite material in which the reinforcement system is used.

It has moreover been found to be advantageous that, prior to introduction into the applicator apparatus, the reinforcement system has been pretreated with at least one substance suitable for the impregnation process. The term preimpregnation can be used for this. This substance suitable for the preimpregnation process preferably differs from the substances which are used for the final impregnation process in the applicator apparatus. This substance suitable for the preimpregnation process is preferably at least one isocyanate, used for saturation of, or dip-coating of, the reinforcement system, without any other component. Since this takes place without any other component that could lead to a chemical reaction, there are no resultant pot life problems.

The docking sites on the fiber surface here become bonded chemically and physically to the PU matrix (key-in-lock principle). Another relevant factor here is in-depth modification of fibers by reactive organic compounds (monomers, prepolymers), with the aim of ensuring secure covalent linkage of reactive coupling agent layers. Because synthetic fibers have smooth surfaces, they provide practically no possibilities for mechanical anchoring, and the “roughening” of the fiber surface therefore serves simultaneously for micromechanical bonding of fiber and matrix.

An embodiment of the process of the invention is briefly described below:

The continuous-filament carbon fiber strand(s) with the preferred weight of from 0.2 to 5 g/m are twisted in a specially equipped twisting machine, giving from 20 to 100 tpm. In a plant for filament processing under controlled tension, this material thus prepared is first treated with a dilute solution of a prepolymeric, but highly reactive isocyanate having 30% content of free isocyanate groups, based on the molar mass of the prepolymer, and having a functionality (=number of free isocyanate groups per molecule) of 2.8%, while minimizing filament tension (about 15 mN/tex), and then the solvent is evaporated in a convection dryer. In a subsequent, spatially separate process, the tension member is subjected to core-depth impregnation with a second solution of a 2C prepolymer, and the solvent is then driven off. In a further stage, during the course of, preferably, from 1 to 10 min (as required by the desired degree of crosslinking) the reaction of the prepolymer to give a polyurethane is completed. This preferably takes place with maximum filament tension (from 100 to 150 mN/tex), in order to stretch (=to orientate) the main-chain polymer of the carbon fiber, and to maximize the modulus of elasticity.

Since the pot life of the 2C prepolymer preferably used is only from 4 to 6 hours, it is not possible to use any conventional dip method for the core-depth impregnation process, since this would lead to high wastage rates at dead volumes in the trough, and the coating is also non-uniform because of the large rise in viscosity of the system.

Nor, on the other hand, can this system be used in the pultrusion process, because it has extremely low viscosity, which is required in order to facilitate the core-depth impregnation process. This known process for the core-depth impregnation of textiles cannot moreover be used with good results for the modification of twisted carbon fibers, since these comprise a high proportion of impurities which inevitably lead to frequent, unproductive break-offs in the pultrusion die intended to calibrate the filaments.

In order to achieve the second object, of core-depth impregnation, in particular of reinforcement systems made of carbon fibers, an apparatus is therefore proposed comprising at least one applicator through which the reinforcement system is passed, and at least one inlet for a substance for the impregnation process. It is preferable that the inlet for the impregnation substance is between the inlet for the reinforcement system and the outlet for the reinforcement system.

In a particularly preferred embodiment, prior to introduction into the applicator apparatus, the reinforcement system has been pretreated with at least one substance suitable for the impregnation process. The term preimpregnation can be used for this. This substance suitable for the preimpregnation process preferably differs from the substances which are used for the final impregnation process in the applicator apparatus. This substance suitable for the preimpregnation process is preferably at least one isocyanate, used for saturation of, or dip-coating of, the reinforcement system, without any other component. This leads to particularly good core-depth impregnation of the reinforcement system, preferably consisting of continuous-filament yarns. Results of this are that the impregnation process can be carried out at low cost and that resources are conserved because the resultant drive belts have a markedly increased lifetime.

Within the inlet for the impregnation substance, the starting materials required for the production of the final impregnation substance can be combined in a mixer. However, it is also possible that the starting materials required are already combined previously and only then are introduced into the inlet. In each case here it is, of course, necessary to consider the appropriate reaction/pot-life times. It is preferable that the final impregnation substance is at least one polyurethane. Starting materials that can be used are therefore any of the starting materials known to the person skilled in the art for the production of polyurethanes.

Starting materials that can be used for the production of polyurethanes are any of the raw materials known for that purpose from the group of the isocyanates, polyols, and chain extenders.

Examples of isocyanates are: aliphatic and aromatic polyisocyanates with functionality at least 2, e.g. hexamethylene 1,6-diisocyanate (HDI), 1-methylcyclo-hexane 2,4- or 2,6-diisocyanate (IPDI), diphenylmethane 4,4′-diisocyanate (MDI), mixtures of tolylene 2,4- and 2,6-diisocyanate (TDI), naphthylene 1,5-diisocyanate (NDI), para-phenylene diisocyanate (PPDI).

Examples of polyols are: polyester polyols by way of example from the group of the adipic acid polyesters having terminal OH groups and with average molar mass from 400 to 4000 g/mol; ether polyols from the group of the C2 to C4 polyethers, for example polyoxytetra-methylene glycols (PTMEG) having terminal OH groups and average molar mass from 400 to 4000 g/mol.

Examples of chain extenders are: aminic chain extenders with functionality at least 2, e.g. 4,4′-diamino-diphenylmethane (MDA), 2,4-diaminotoluene (TDA),
4,4′-methylenebis(2-chloroaniline) (MBOCA),
4,4′-methylene-bis(3-chloro-2,6-diethylaniline) (MCDEA);
diolic chain extenders with functionality at least 2, e.g.
1,2-ethanediol, 1,3-propanediol, 1,4-butanediol, 1,6-hexanediol.

Polyurethane prepolymers (PU prepolymers) are produced via a preliminary reaction of isocyanate with polyol. Production of these can use the abovementioned isocyanates and polyols. In combination with one of the abovementioned chain extenders, they form the 2C PU prepolymer.

An embodiment of the apparatus of the invention is briefly described below:

The applicator is used as follows: a precisely defined quantity of 2C PU prepolymer solution is introduced in a static mixer of the application apparatus by means of a 2C peristaltic pump operating at the speed of which it is capable. The length of the applicator is sufficient to allow enough time for the core-depth impregnation process to penetrate into all of the interstices of the filament bundle. It is preferable that the applicator is tubular, the length of the tube here being a function of the viscosity of the liquid. The viscosity of the coating liquid or impregnation liquid is preferably from 10 to 100 mPa*s, particularly preferably from 20 to 60 mPa*s. By using the frequency dependency of the known viscosity, the time required for the liquid to achieve core-depth impregnation can be calculated precisely by way of the WLF relationship, and the tube length can be designed as a function of plant velocity. The resultant length is from 10 to 50 cm, depending on the linear density of the material. The quantity of polymer has to be controlled precisely because although protecting polymer is intended to fill all of the cavities between the filaments, the intention is also not to exceed this essential quantity, because this has a disadvantageous effect on the modulus of elasticity of the reinforcement system.

The radii of the application tube are intended to assist the impregnation process and to minimize the excess of the PU solution, since then the solution always fills the tube, even in the event of variations in the take-up of the preparation, caused by variations in linear density or in fiber-finishing, caused by the carbon yarn production process. For reasons related to production techniques, furthermore, the tube should permit passage of a connection between filaments (for example splice, knot, or the like), so that continuous treatment is possible. In one preferred variant the internal diameter of the tube is from 3 to 20 times the filament diameter. The total take-up of preparation of polyisocyanate and PU solution is preferably from 15 to 25%, particularly preferably from 17 to 20%, based in each case on the linear density as unit for total filament weight. The above data are equally valid for the process of the invention.

The stiffness value and the flexural fatigue resistance of the reinforcement system can be used to assess lifetime. Laboratory testing gives a Taber stiffness (based on ISO 5628) of from 100 to 300 SU for a PU-impregnated carbon reinforcement system in the invention, preferably from 180 to 260 SU; stiffness in the 3-point flexural test (based on ISO 178 or DIN 53457) is from 4000 to 6000 N/mm, with a flexural modulus of from 30 to 50 MPa.

The number of cycles prior to fracture in the MIT folding endurance test (based on ISO 32100 or ISO 5625) is more than 500 with 1.5 kg of counterload, preferably from 700 to 800.

A reinforcement system produced by means of the apparatus of the invention and/or by means of the process of the invention has particularly good suitability for use in force-transmission belts, which are often also called drive belts.

### BRIEF DESCRIPTION OF THE DRAWINGS

The invention will now be described with reference to the drawings wherein:

FIG. 1 shows a filament bundle impregnated with polymer, preferably PU; and,

FIG. 2 shows an applicator apparatus.

### DESCRIPTION OF THE PREFERRED EMBODIMENTS OF THE INVENTION

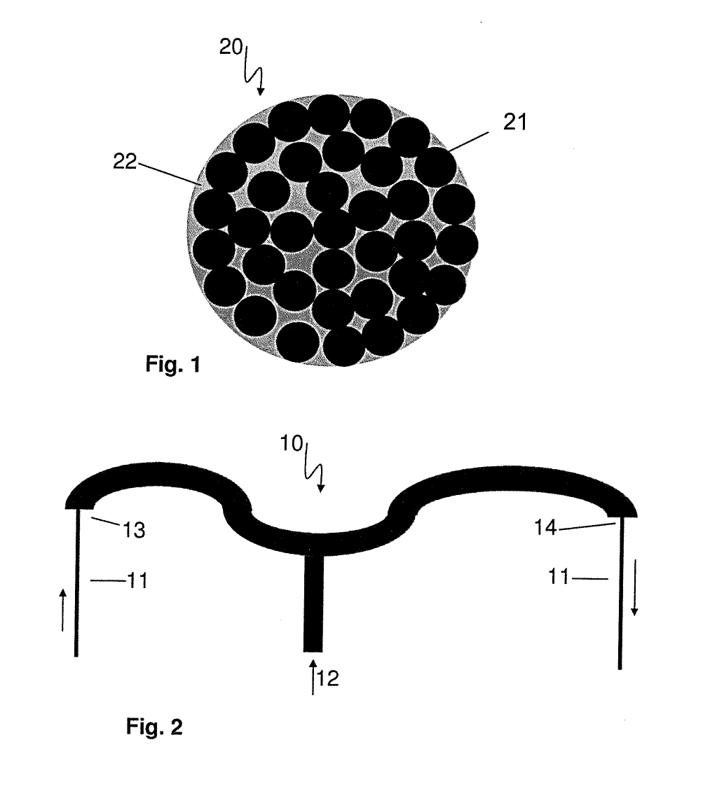

FIG. 1 shows a carbon thread 20 made of a bundle of carbon fiber filaments 21, core-depth impregnated with at least one polymer 22.

FIG. 2 shows the applicator apparatus 10 of the invention with the filament path of the reinforcement system (13, 14), and with an inlet 12 for the impregnation substance between the inlet 13 of the reinforcement system and the outlet 14 of the reinforcement system.

It is understood that the foregoing description is that of the preferred embodiments of the invention and that various changes and modifications may be made thereto without departing from the spirit and scope of the invention as defined in the appended claims.

### KEY

### Part of the Description

20 Carbon thread
21 Carbon fiber filaments
22 Polymer
10 Applicator apparatus
11 Reinforcement system
12 Inlet for impregnation substance
13 Inlet of reinforcement system
14 Outlet of reinforcement system

What is claimed is:

1. A process for the production of an impregnated reinforcement system comprising:
introducing a reinforcement system into an applicator apparatus;
introducing at least one substance for the impregnation of the reinforcement system into the applicator apparatus; and,
discharging the impregnated reinforcement system.

2. The process as claimed in claim 1, wherein the reinforcement system is composed of at least one carbon fiber.

3. The process as claimed in claim 1 further comprising:
pretreating the reinforcement system with a preimpregnation substance before the reinforcement system is introduced into the applicator apparatus.

4. The process as claimed in claim 1, wherein the substance for the impregnation of the reinforcement system is at least one 2C PU prepolymer solution.

5. The process as claimed in claim 1, wherein the applicator apparatus is tubular.

6. An apparatus for producing an impregnated reinforcement system comprising:
at least one applicator through which a reinforcement system is passed; and,
at least one inlet for a substance for the impregnation of the reinforcement system.

7. The apparatus as claimed in claim 6, wherein the at least one inlet for the substance for the impregnation of the reinforcement system is provided between an inlet for the reinforcement system and an outlet for the reinforcement system.

8. The apparatus as claimed in claim 6, wherein the reinforcement system is composed of at least one carbon fiber.

9. The apparatus as claimed in claim 6, wherein the reinforcement system has been pretreated with at least one preimpregnation substance.
